(19) United States
(12) Patent Application Publication
(10) Pub. No.: US 2011/0315627 A1
(43) Pub. Date: Dec. 29, 2011

(54) METHOD OF BIOLOGICAL WASTE-WATER TREATMENT

(76) Inventor: Jerzy Robert Slusarczyk, Poznan (PL)

(21) Appl. No.: 13/168,743

(22) Filed: Jun. 24, 2011

(30) Foreign Application Priority Data
Jun. 24, 2010 (PL) P.391606

(51) Int. Cl. C02F 3/30

(52) U.S. Cl. 210/605; 210/195.1

(57) ABSTRACT

A biological waste-water treatment using a biological reactor is described where the processes are conducted in an alternating and joint, aerobic zone, anoxic zone and aerobic zone arrangement. Raw waste-water is transferred to the aerobic zone and/or to the anoxic zone. The waste-water is also transferred from the last anoxic zone to the last aerobic zone, which acts as an exit from the biological reactor. In the process of external recirculation to the aerobic zone, sludge from the bottom of the secondary precipitation tank is moved to the aerobic zone. In the process of internal recirculation the content of the last aerobic zone is divided between anoxic zone and aerobic zone. From the last aerobic zone, waste-water is transferred with the sludge to the secondary precipitation tank, where the clean waste-water is separated from the sludge on the bottom of the secondary precipitation tank.

### PRIORITY CLAIM

This application claims priority to Polish Patent Application P.391606 [WIPO ST 10/C PL 391606]-/- that was filed with the Patent Office of the Republic of Poland on Jun. 24, 2010.

### FIELD OF THE INVENTION

The subject of the invention is a method of biological waste-water treatment, which may be applied in municipal services, various branches of industry, agriculture, and for household, industrial, and related areas of waste-water containing biodegradable substances.

### BACKGROUND

One problem with existing biological waste-water treatments is an increased technogenic load on the environment, due to the formation of excess activated sludge. Excess sludge leads to the use of equipment for processing, storage and disposal of the sludge and to the use of reagents applied in the processing of waste-water sludge, leading to the need for landfill sites for the created sludge. All this additional processing results in secondary pollution and the use of additional land for disposal.

Another problem is the emission or release of harmful substances to the atmosphere, including those with unpleasant odors like hydrogen sulphide, and these emissions create the need to increase a size of a sanitary protection zone—the distance from the waste treatment plant to the housing areas. In addition, the need for continuous removal of secondary pollutants, in the form of wet sludge from primary precipitation tanks and the excess of activated sludge from the secondary precipitation tanks does not allow for a closed waste-water treatment cycle. This lack of a closed cycle can prevent the automation of the process control as a whole and make a guaranteed quality of waste-water from the cleaning equipment while reducing technogenic load on the environment virtually impossible.

A three-level biological waste-water treatment system has been used. Such systems can use a biological reactor with three zones in the system: an anaerobic zone, an anoxic zone and an aerobic zone. This allows waste-water to be fed to an anaerobic zone situated at the top of the reactor. In the process of the external recirculation, sludge from the secondary precipitation tank mixes with the inflow of waste-water from the first zone and during the recirculation of the inside content of the aerobic zone, the sludge is moved to the anoxic zone.

A five-stage biological waste-water treatment has also been used, which has a biological reactor containing five zones within the system, including: an anaerobic zone, an anoxic zone, an aerobic zone, a second anoxic zone and a second aerobic zone. This system allows waste-water to be fed to the anaerobic zone situated at the top of the reactor. In the process of the external recirculation, sludge from the secondary precipitation tank mixes with the inflow of waste-water from the first zone. Then during the recirculation of the inside content of the third aerobic zone, the sludge is moved to the second anoxic zone.

### BRIEF DESCRIPTION OF THE DRAWINGS

FIG. 1 is a block diagram illustrating the use of an example biological reactor containing 3 zones.

FIG. 2 illustrates the use of an example biological reactor with 5 zones.

FIG. 3 illustrates the use of an example biological reactor containing n zones.

### DETAILED DESCRIPTION

This invention can minimize the resulting sludge, reduce the emission of substances with an unpleasant odor into the air, and can reduce or even totally eliminate the chemical reagents used in waste-water treatment.

This biological waste-water treatment uses a biological reactor with outside and inside recirculation processes. The waste-water technology includes alternating joint aerobic zones with at least one anoxic zone. Specifically, the interleaved zone may include at least one aerobic zone, anoxic zone and another aerobic zone. Raw waste-water can be fed from the last anoxic zone (depending on its characteristics) to the aerobic zone situated at the top of the reactor and/or to the anoxic zone. In addition, the waste-water is transferred to the last aerobic zone constituting an exit from the biological reactor.

Furthermore, in the process of outside recirculation, the sludge accumulated in the secondary precipitation tank is moved or transferred to the aerobic zone situated at the top or beginning of the reactor. During the process of inside recirculation of the waste-water content from the last aerobic zone, sludge and/or waste water is divided between at least one anoxic zone or aerobic zone and moved from the last aerobic zone to those anoxic and/or aerobic zones. Further, waste-water from the last aerobic zone is moved with the sludge to the secondary precipitation tank where the clean waste-water is separated from the sludge, which precipitates as sediment to the bottom of the secondary precipitation tank. Waste-water cleaned from the excess sludge left remaining on the bottom of the secondary precipitation tank can be discharged from the secondary precipitation tank.

Raw waste-water can also be carried through the biological reactor, which contains at least two aerobic zones and at least one anoxic zone. Multiple anoxic zones and aerobic zones can be used in an interleaved order, as long as the number of anoxic zones occurring in the biological reactor is smaller by one then the number of the aerobic zones. This technology does not contain any anaerobic zones in the bioreactor. According to a further example, oxygen concentration in the anoxic zone can be maintained in the range from 0.1 to 0.5 mg of G₂/L during the process, and in the aerobic zone the oxygen concentration can be maintained in the range of 1.5-3.5 mg 0₂/L.

In another example, the flow of sludge recirculated from the secondary precipitation tank is adjusted in proportion to the suspended sediment layer above the bottom of the secondary precipitation tank. The suspended sediment layer may be maintained in a range of no more than 75% of the active height of the secondary precipitation tank. In a further example, the retention time of a mixture of waste-water and sludge in the first aerobic zone is not more than 6 hours, while the retention time of a mixture of waste-water and sludge in the other aerobic zones and anoxic zones is no greater than 4.5 hours.

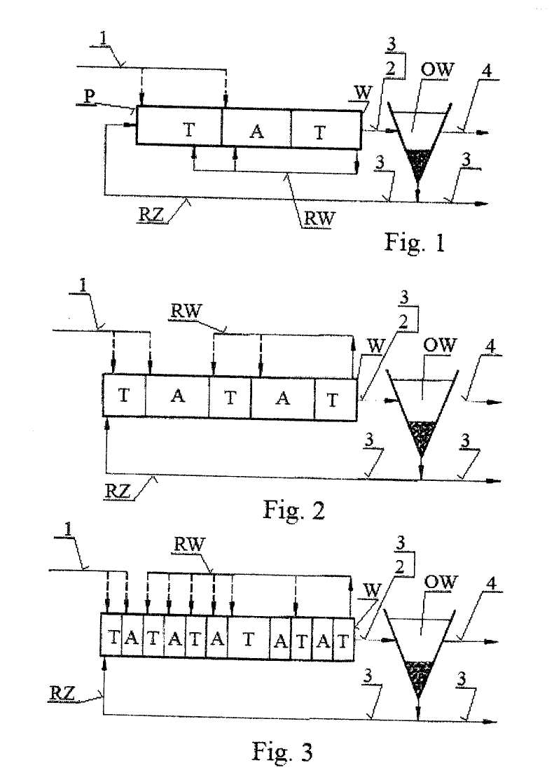

The method of biological waste-water treatment will further be explained using three implementation examples, as illustrated in the drawings. FIG. 1 is a block diagram illustrating the use of an example biological reactor containing 3 zones. FIG. 2 illustrates the use of an example biological reactor with 5 zones, and FIG. 3 illustrates the use of an example biological reactor containing N zones.

### Example 1

In one example of the biological waste-water treatment, the biological reactor is used where the processes are conducted with alternating joint aerobic zone T, anoxic zone A and aerobic zone T. Raw waste-water 1 (depending on its characteristics) is fed to the aerobic zone T situated at the top or beginning of the reactor P and to the anoxic zone A. From the last anoxic zone A the waste-water 2 is transferred to the last aerobic zone T constituting an exit from the biological reactor W.

In the process of outside recirculation RZ the sludge 3 accumulated at the bottom of the secondary precipitation tank OW is moved to the aerobic zone T. The aerobic zone is situated at the top of the reactor P. In the process of internal recirculation RW, the re-circulated waste-water and/or sludge content of the last aerobic zone T is divided between anoxic zone A and aerobic zone T and transferred to the anoxic zone A and aerobic zone T. The recirculation can take place using an internal or external re-circulation device with pumps and pipes or a re-circulation system that moves the waste water and/or accumulated sludge to the desired zone.

From the last aerobic zone T, waste-water 2 is carried with the sludge 3 to the secondary precipitation tank OW, where the waste-water 4 is separated from the sludge 3 as the sludge precipitates to the bottom of the secondary precipitation tank OW. Waste-water 4 and the excess sludge 3, located at the bottom of the secondary precipitation tank OW, can be discharged from the secondary precipitation tank OW.

The secondary precipitation tank or secondary sedimentation tank provides conditions to allow biochemical processes to breakdown sludge. This secondary precipitation tank is a zone where biochemical processes take place to enable the reduction or breakdown of excessive sludge. This is in contrast to the previous use of a secondary precipitation tank where the tank is used simply to sediment, recirculate and finally collect sludge for disposal. The secondary precipitation tank provides an environment for bacteria in the tank to consume older sludge and breakdown the components of the waste water to meet regulatory standards. Examples of biochemical processes may include processes that minimize the biomass, perform endogenic respiration utilizing the chemical energy stored in the old biomass, or break down biological and chemical solids in the system.

During the process, oxygen concentration in the anoxic zone A can be maintained in the range from 0.1 to 0.5 mg 0₂/L, and in the aerobic zone T the oxygen concentration can be maintained in the range from 1.5-3.5 mg 0₂/L. The flow of sludge 3 re-circulated from the secondary precipitation tank OW can be adjusted in proportion to the suspended sediment layer 3 above the bottom of the secondary precipitation tank OW, and the suspended sediment layer may be maintained in the range of no more than 75% of the active height of the secondary precipitation tank OW. The retention time of a mixture of waste-water 2 and sludge 3 in the first aerobic zone T is not more than 6 hours, while the retention time of a mixture of waste-water 2 and sludge 3 in the other aerobic zones T and anoxic zones A is no greater than 4.5 hours.

### Example 2

In another example of biological waste-water treatment, the biological reactor is used where the processes are conducted in the alternating joint aerobic zone T, anoxic zone A and aerobic zone T and anoxic zone A and aerobic zone T. Raw waste-water (depending on its characteristics) is fed to the aerobic zone T situated on the top (or beginning) of the reactor P or to the anoxic zone A. The waste-water 2 is transferred from the last anoxic zone A to the last aerobic zone T constituting an exit from the biological reactor W. In the process of outside recirculation RZ to the aerobic zone T, situated at the top of the reactor P, the sludge 3 accumulated in the secondary precipitation tank OW is moved or pumped to the first aerobic zone T. In the process of internal recirculation RW, the waste-water and/or sludge contents of the last aerobic zone T are divided between anoxic zone A or aerobic zone T as the sludge is moved or pumped out of the last aerobic zone T.

From the last aerobic zone T, the waste-water 2 is moved with the sludge 3 to the secondary precipitation tank OW where the clean waste-water 4 is separated from the sludge 3. Specifically the sludge can precipitate to the bottom of the secondary precipitation tank OW to form sediment. Waste-water 4 and the excess sludge 3, located at the bottom of the secondary precipitation tank OW, can be discharged from the secondary precipitation tank OW.

During the example process, oxygen concentration in the anoxic zone A may be maintained in the range from 0.1 to 0.5 mg 0₂/L, and in the aerobic zone T the oxygen concentration may be maintained in the range from 1.5-3.5 mg 0₂/L. The flow of sludge 3 re-circulated from the secondary precipitation tank OW may be adjusted in proportion to the sediment layer 3 suspended above the bottom of the secondary precipitation tank OW, which may be maintained in the range of no more than 25% of the active height of the secondary precipitation tank OW. The retention time of a mixture of waste-water 2 and sludge 3 in the first aerobic zone T is not more than 6 hours, while the retention time of a mixture of waste-water 2 and sludge 3 in the other aerobic zones T and anoxic zones A is no greater than 4.5 hours.

### Example 3

In this example method of the biological waste-water treatment, the biological reactor uses processes conducted in the alternating joint aerobic zones T, and anoxic zones A. The number of anoxic zones A can be one less than the number of aerobic zones T in the biological reactor, and the anoxic zones A can alternate with the aerobic zones T. Raw waste-water 1 (depending on its characteristics) is transferred to the aerobic zone T located at the top (or beginning) of the reactor P and/or to the anoxic zone A. From the last anoxic zone A waste-water 2 is transferred to the last aerobic zone T which can include an exit from the biological reactor W.

In the process of the external recirculation RW to the aerobic zone T, located at the top of the reactor P, the sludge 3 accumulated at the bottom of the secondary precipitation tank OW moves to the top of the reactor P. In the process of internal recirculation RW, the content of the last aerobic zone T is divided between anoxic zones A or aerobic zones T. From the last aerobic zone T, the waste-water 2 with the sludge 3 flows to the secondary precipitation tank OW, where the clean waste-water 4 is separated from the sludge 3, and the sludge precipitates to the bottom of the secondary precipitation tank OW. The clean waste-water 4 on top of the excess sludge 3 on the bottom of the secondary precipitation tank OW can be discharged from the secondary precipitation tank OW.

During the example process, oxygen concentration in the anoxic zone A may be maintained in the range from 0.1 to 0.5 mg 0₂/L, and in the aerobic zone T the oxygen concentration may be maintained in the range from 1.5-3.5 mg 0₂/L. The flow of activated sludge 3, recirculated from the secondary precipitation tank OW can be adjusted in proportion to the sediment layer 3 suspended above the bottom of the secondary precipitation tank OW, which may be maintained in the range of no more than 75% of the active height of the secondary precipitation tank OW. The retention time of a mixture of waste-water 2 and sludge 3 in the first aerobic zone T is not more than 6 hours, while the retention time of a mixture of waste-water 2 and sludge 3 in the other aerobic zones T and anoxic zones A is no greater than 4.5 hours.

This technology can reduce the release of substances with an unpleasant smell into the air by removing the sorbate organic substances from the insoluble additives. In addition, this technology does not use a primary precipitation tank, which leads to lower investment costs associated with building waste treatment facilities and to lower operating costs. The design of the treatment devices with a capacity of 25,000 m³/day can also be more ecologically friendly because the size of the sanitary protection zone can be reduced from 450 meters to even 20 meters. Reducing operational costs is also possible by optimizing the air consumption, reducing the excess sludge discharged, providing the possibility of discontinuing the use of expensive reagents, and reducing of the cost of electrical energy required to clean waste water.

1. A method of biological waste-water treatment using a biological reactor, comprising:
transferring raw waste-water to an aerobic zone located at a top of the biological reactor;
transferring waste-water from the aerobic zone to an anoxic zone;
transferring waste-water from the anoxic zone to a last aerobic zone which acts as an exit from the biological reactor;
recirculating sludge inside the biological reactor back to the anoxic zone and aerobic zone;
transferring waste-water to a secondary precipitation tank to separate clean water from sludge which accumulates in the secondary precipitation tank; and
discharging clean water from the secondary precipitation tank.

2. The method as in claim 1, further comprising recirculating sludge from the secondary precipitation tank externally to the top of the biological reactor.

3. The method as in claim 1, wherein the raw waste water is initially sent to the anoxic zone in addition to the aerobic zone.

4. The method as in claim 1, wherein the raw waste water is transferred to the anoxic zone instead of the aerobic zone.

5. A method of biological waste-water treatment in which a biological reactor is used, and where the processes of external and internal recirculation are used, comprising:
interleaving at least an aerobic zone, an anoxic zone and a second aerobic zone, configured to process waste-water;
transferring waste-water to the aerobic zone situated at a top of the reactor and/or to the anoxic zone,
transferring waste-water from the last anoxic zone to the last aerobic zone constituting an exit from the biological reactor;
accumulating sludge in the secondary precipitation tank;
externally re-circulating sludge from the secondary precipitation tank to the aerobic zone;
internally re-circulating waste-water with sludge of the last aerobic zone to at least one anoxic zone and/or aerobic zone, excepting the last aerobic zone; and
separating clean waste-water from the sludge using the secondary precipitation tank for discharge.

6. The method of biological waste-water treatment according to claim 5, wherein raw waste-water is carried through the biological reactor, which includes more than two aerobic zones and more than one anoxic zone in an alternating arrangement, while the number of anoxic zones present in the biological reactor is smaller by one than the number of the aerobic zones.

7. The method of the biological waste-water treatment according to claim 5, wherein oxygen concentration in the anoxic zone is maintained in the range from 0.1 to 0.5 mg 0₂/L and in the aerobic zone the oxygen concentration is maintained in the range from 1.5-3.5 mg 0₂/L.

8. The method of biological waste-water treatment according to claim 5, wherein the transfer of the sludge recirculated from the secondary precipitation tank is adjusted in proportion to the suspended sediment layer, which is maintained in the range of no more than 75% of the active height of the secondary precipitation tank.

9. The method of the biological waste-water treatment according to claim 5 wherein the retention time of the waste-water mixture and sludge in the first aerobic zone is not more than 6 hours and the retention time of a mixture of waste-water and sludge in other aerobic zones and anoxic zones is not greater than 4.5 hours.

10. A system for biological waste-water treatment using a biological reactor, comprising:
an aerobic zone located at a beginning of the biological reactor to receive waste-water;
to an anoxic zone to receive waste-water from the aerobic zone;
a last aerobic zone to receive waste-water from the anoxic zone and which acts as an exit from the biological reactor;
a recirculation device to recirculate sludge inside the biological reactor back to the anoxic zone and aerobic zone; and
a secondary precipitation tank to receive waste-water from the last aerobic zone to separate clean water from sludge which accumulates in the secondary precipitation tank.

11. The system as in claim 1, further comprising an external recirculation device for recirculating sludge from the secondary precipitation tank externally to the beginning of the biological reactor.

12. The system as in claim 1, wherein the secondary precipitation tank provides conditions to allow biochemical processes to breakdown sludge as part of the bioreactor.

13. The system as in claim 1, wherein there are no anaerobic zones in the bioreactor.
